(19) United States
(12) Patent Application Publication
(10) Pub. No.: US 2009/0265138 A1
(43) Pub. Date: Oct. 22, 2009

(54) TESTING SYSTEM AND METHOD FOR TESTING A VIBRATION FUNCTION OF A MOBILE PHONE

(75) Inventors: QING-HUA LIU, Shenzhen City (CN); GUO-HUA LIU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) Co., LTD., Shenzhen City (CN); HON HAI PRECISION INDUSTRY CO., LTD., Tu-Cheng (TW)

(21) Appl. No.: 12/187,867

(22) Filed: Aug. 7, 2008

(30) Foreign Application Priority Data
Apr. 21, 2008 (CN) 200810301220.2

(51) Int. Cl. G06F 11/277

(52) U.S. Cl. 702/183

(57) ABSTRACT

A testing system includes a mobile phone motherboard, a motor connected to the motherboard, a multimeter capable of measuring vibrating frequency and voltage of the motor, and a computer. The computer has an output port capable of sending commands to the mobile phone motherboard to instruct the motor to vibrate and an input port capable of receiving the measured vibration frequency and voltage of the motor. The computer has a main test procedure capable of comparing the measured frequency and voltage of the motor with predetermined parameters. A testing method utilizing the above described testing system is also disclosed.

### BACKGROUND

1. Technical Field

The present invention relates to a testing system and method for testing a vibration function of a mobile phone.

2. Description of Related Art

Products are typically tested at several stages of assembly to identify potential issues with components at a subassembly level and ensure the final product meets all of a manufacturer's requirements. Motherboards are a critical component of mobile phones and should be tested before being installed in the mobile phones. One such test is to test a vibration function of the mobile phones. A typical method of testing the vibration function of a mobile phone motherboard includes connecting the mobile phone motherboard to a motor, sending commands to the motherboard to drive the vibrating motor, detecting the vibrating motor, and determining if the motor is vibrating normally. The typical method requires few test fixtures and can be easily performed. However, the test results are obtained from subjective judgment of operators and thus, not highly accurate.

Therefore, a new testing system and method for accurately testing the vibration function of a mobile phone is desired to overcome the above-described deficiencies.

### BRIEF DESCRIPTION OF THE DRAWINGS

FIG. 1 is a block diagram of an embodiment of a testing system for testing a vibration function of a mobile phone; and

FIG. 2 is a flow chart illustrating a method for testing a vibration function of a mobile phone.

### DETAILED DESCRIPTION OF THE EMBODIMENTS

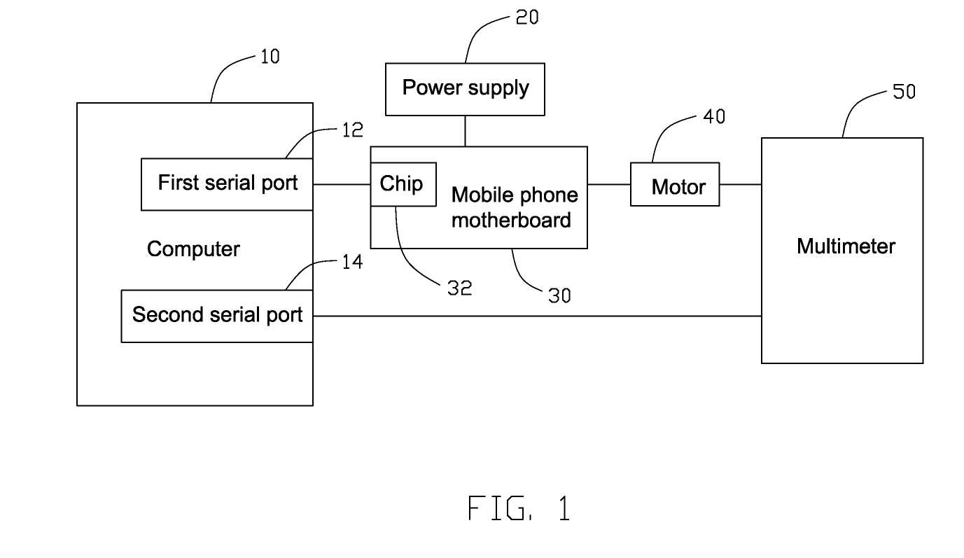

FIG. 1 is a block diagram of an embodiment of a testing system (not labeled) for testing a vibration function of a mobile phone. The testing system includes a computer 10, a power supply 20, a mobile phone motherboard 30, a motor 40, and a multimeter 50. The computer 10 includes a first serial port 12 and a second serial port 14. The power supply 20 provides power to the mobile phone motherboard 30. The mobile phone motherboard 30 includes a chip 32 connected to the first serial port 12. The motor 40 is connected to the mobile phone motherboard 30. The multimeter 50 is capable of measuring and transmitting voltage and vibration frequency of the motor 40 to the computer 10 via the second serial port 14.

The computer 10 is configured with a main test procedure which sends invoking commands to the chip 32. The chip 32 is configured with a vibration test program which is invoked after receiving the invoking commands from the computer 10, signaling the motor 40 to either vibrate or stop vibrating. The main test procedure in the computer 10 generates parameters of a frequency range that simulates a mobile phone vibrating, and parameters of a voltage range corresponding to voltages used by vibrating motors of the mobile phone. After the multimeter 50 measures the vibration frequency and voltage of the motor 40 and sends the measured frequency and voltage to the computer 10, the main test procedure in the computer 10 is capable of comparing the measured frequency and voltage with the parameters to determine whether the motor 40 is vibrating normally.

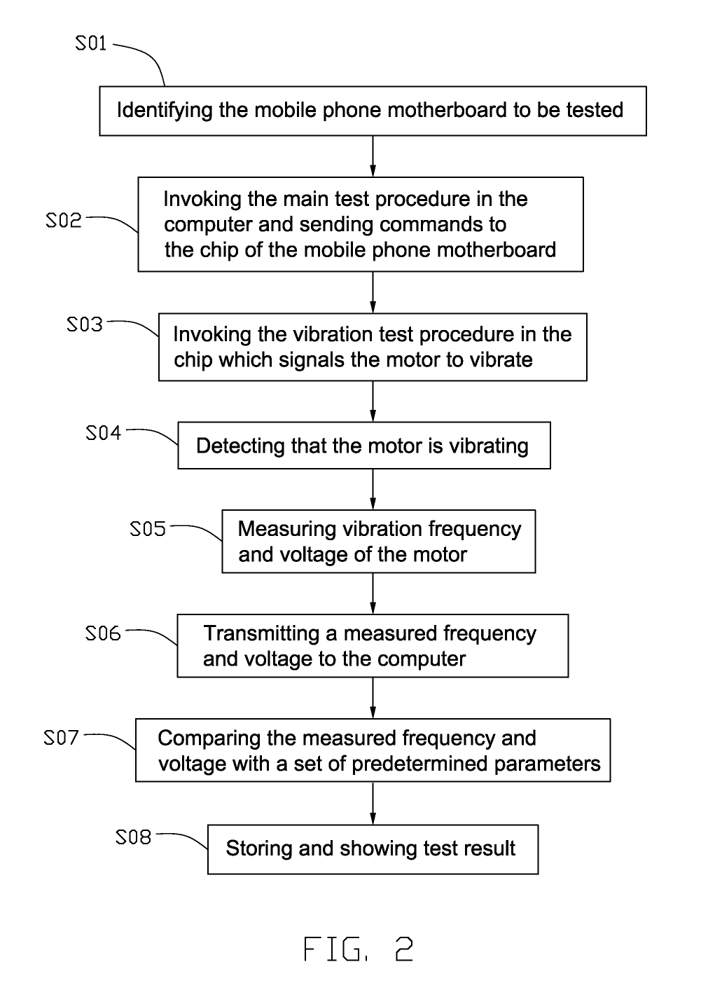

FIG. 2 is a flow chart illustrating a method for testing the vibration function of the mobile phone. Depending on the embodiment, certain of the blocks described below may be removed, others may be added, and the sequence of blocks may be altered. In one embodiment, the method for testing the vibration function of a mobile phone utilizing the above-described testing system includes the following blocks:

S01: identifying the mobile phone motherboard 30 to be tested;

S02: invoking the main test procedure in the computer 10 and sending commands to the chip 32 via the first serial port 12;

S03: invoking the vibration test procedure in the chip 32 which signals the motor 40 to vibrate;

S04: detecting that the motor 40 is vibrating;

S05: measuring vibration frequency and voltage of the motor 40 while the motor 40 is vibrating with the multimeter 50;

S06: transmitting a measured frequency and a measured voltage to the computer 10 via the second serial port 14;

S07: comparing the measured frequency and voltage with a set of predetermined parameters in the test procedure in the computer 10; and

S08: storing the test result in the computer 10 and either displaying a message on a display (not shown), such as PASS, if the measured frequency is within the predetermined frequency range and the measured frequency is within the predetermined voltage range, or displaying a message, such as FAIL, if either the measured frequency is not within the predetermined frequency range or the measured frequency is not within the predetermined voltage range.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A testing system comprising:
a mobile phone motherboard;
a motor electrically connected to the mobile phone motherboard;
a multimeter configured to measure a vibrating frequency and voltage of the motor; and
a computer having:
a main test procedure capable of comparing the measured frequency and voltage of the motor with predetermined parameters;
an output port; and
an input port,
wherein the computer is configured to send commands to the mobile phone motherboard to signal the motor to vibrate via the output port, and receive the measured vibration frequency and voltage of the motor via the input port.

2. The testing system of claim 1, wherein the mobile phone motherboard comprises a chip having a vibration test procedure, the chip is configured to receive commands from the computer and instruct the motor to vibrate.

3. The testing system of claim 2, wherein the input port is a serial port electrically connected to the chip.

4. The testing system of claim 1, wherein the output port of the computer is a serial port electrically connected to the multimeter.

5. A testing method for testing a vibration function of an electronic product comprising:
sending commands to the electronic product to instruct a motor of the electronic product to vibrate;
measuring vibration frequency and voltage of the motor;
comparing the measured frequency and voltage of the motor with predetermined parameters; and
determining whether the vibration function of the electronic device meets a predetermined standard.

6. The testing method of claim 5, further comprising running a main test procedure in a computer before sending commands to the electronic product.

7. The testing method of claim 6, further comprising receiving the commands, running a vibrations test procedure in the electronic device, and instructing the motor to vibrate after sending commands to the electronic product.

8. The testing method of claim 5, wherein the predetermined parameters comprises a predetermined frequency range and a predetermined voltage range.

9. The testing method of claim 8, wherein the predetermined standard comprises determining if a measured frequency of the motor is within the predetermined frequency range and if a and the measured voltage of the motor is within the determined voltage range; wherein a vibration function test is passing if the measured frequency of the motor is within the predetermined frequency range and the measured voltage of the motor is within the determined voltage range; a vibration function test is failing if either the measured frequency of the motor is not within the predetermined frequency range or if theand the measured voltage of the motor is not within the determined voltage range.

10. The testing method of claim 6, wherein the commands is sent to the electronic device via a first serial port of a computer.

11. The testing method of claim 10, wherein the commands is received by a chip having a vibration test procedure.

12. The testing method of claim 5, further comprising sending the measured frequency and voltage to a second serial port of a computer.

13. A testing system for testing an electronic device with a vibration function comprising:
a computer having a main test procedure capable of sending commands to instruct a motor of the electronic device to vibrate; and
a multimeter capable of measuring vibration frequency and voltage of the motor and sending a measured vibration frequency and a measured voltage of the motor to the computer;
wherein the computer is capable of comparing the measured vibration frequency and voltage of the motor with predetermined parameters to determine whether a vibration function of the electronic device is qualified.

14. The testing system of claim 13, wherein the computer comprises a first serial port, wherein the commands are transferred out to the electronic device via the first serial port.

15. The testing system of claim 14, wherein the computer further comprises a second serial port, wherein the computer receives the measured frequency and voltage of the motor via the second serial port.
